(19) United States
(12) Patent Application Publication
(10) Pub. No.: US 2023/0185692 A1
(43) Pub. Date: Jun. 15, 2023

(54) Highly Tested Systems

(71) Applicant: John D. Campbell, North Ogden, UT (US)

(72) Inventor: John D. Campbell, North Ogden, UT (US)

(21) Appl. No.: 18/080,271

(22) Filed: Dec. 13, 2022

Related U.S. Application Data
(60) Provisional application No. 63/289,626, filed on Dec. 14, 2021.

(51) Int. Cl. G06F 11/36; G06F 8/30

(52) U.S. Cl. CPC G06F 11/3608; G06F 8/30; G06F 11/3692; G06F 11/3684

(57) ABSTRACT

A class of systems for searching the code of conventional software, programmable hardware like Field Programmable Gate Arrays and Application Specific Integrated Circuits for behaviors of interest. This enables behavioral requirements and testing to be applied and automatically positioned in the code. Five using communities are envisioned for variations on the invention. These are Software Safety Program Administration, developers of software Intellectual Property (IP) modules and hardware IP modules, Systems Integrators of such IP, IP brokers, and Cyber Security Vendors. The usage of the invention by these communities is sufficiently different that there are separate and unique claims specific to the needs of each group.

### CROSS-REFERENCE TO RELATED APPLICATION

This application which claims the benefit of provisional application Ser. No. 63/289,626, which was filed on Dec. 14, 2021. This application also claims the benefit of provisional patent application Ser. No. 63/423,466, which was filed on Nov. 7, 2022.

### BACKGROUND OF THE INVENTION

### Field of the Invention

This invention relates to testing of digital systems including software, Field Programmable Gate Arrays (FPGA) and Application Specific Integrated Circuits (ASICS). Currently the locations in a software program or FPGA design where a behavioral requirement is applicable have to be found manually and implemented by human labor. There has been no definitive method for locating where behavioral requirements impact an FPGA design or software program. There are three consequential problems. First, the person responsible can be in error (resulting in a bug). Second, as the software or FPGA design evolves, the proper site for it can change (resulting in a bug with delayed manifestation). In like manner, embedded testing behavioral requirements can fail to test the right thing. Third, testing to ensure compliance with a behavioral requirement may not check what was intended. This invention solves these problems by locating relevant sites by pattern match. Pattern matching is enabled by formatting the machinery as a behavioral network. It automates the manual process of locating relevant sites and automatically adapting the implementation as the design evolves. The mechanism enabling this is pattern matching the behavioral requirement to the behavior of the design. This pattern matching is itself enabled by formatting the machinery in what we call a Behavioral Network. Together, this enables behavioral requirements couched in terms of desired changes in behavior patterns that enable automatically locating the spots where changes are needed and implementing the changes there. This results in lower levels of labor involved in software development and fewer bugs needing repair. The third problem is addressed by enabling the verification of the test itself, i.e. testing the testing. A Behavioral Network selects sequences of actions the software or FPGA design does (i.e. behaviors) with decision points where alternative sequences are selected. This enables patterns of behavior to be specified for recognizing where to apply behavioral requirements. Nonbehavioral characteristics that may be necessary (such as array size information) are segregated into elements that preserve them but allow them to be ignored in terms of behavior patterns.

Behavioral requirements have three categories: 1) Functional behavioral requirements that constrain application behavior, 2) Test behavioral requirements that ascertain whether the software/FPGA design is behaving as intended, and 3) Verification behavioral requirements that ascertain whether testing behavioral requirements achieve what was intended. Functional behavioral requirements remain in the delivered application, whereas test behavioral requirements and verification behavioral requirements serve testing needs, but ordinarily do not encumber the delivered application.

Of course, the behavioral requirement can still be improperly specified. Consequently, testing is still needed, but need not be implemented manually. The same techniques of specifying by means of pattern matching the testing sites results in the same level of behavioral accuracy for testing as for behavioral requirement specification. The system even supports testing of testing to ensure that the right things are tested for as many layers of test assurance as may be necessary.

### Description of the Related Art

Gerard J Holzmann, Computing Edge, December 2021, p 29

Holzmann describes a tool that parses a C program and provides the tokens to a pattern matching function so that patterns of symbol usage can be located in a codebase. This bears a superficial resemblance to the current invention because of its reliance on pattern matching. But it relates to occurrences of tokens in parse streams rather than program behavior. Holzmann's tool enables one to search for a variable used in a particular way, and then in a second particular way. His example was capture of a string length and then manipulation of that string. His tool focuses small windows into surface level features. By contrast, the present invention enables pattern matching of behaviors rather than syntactical context. Pattern matching of behaviors enables addressing of semantic meaning of the program or digital system and correlation of behavior across broad portions of a complex mechanism.

U.S. Pat. No. 11,372,978 B2

This patent discovers malicious properties in a software package by including it in a generic software package with known functionality. The integrated package is investigated by static analysis or by running it. The package is observed to determine a score and based on that score it applies a threshold for flagging as malicious. This technique requires the differentiation of behavior due to the known program or due to the package under investigation. There is a preconceived idea of the kinds of things that are malicious. If it is malicious, but doesn't do the things that they were watching for, it won't be detected. Distinguishing between behaviors of the generic package and the package under investigation is a problem that our invention does not share.

United States Patent Number 20210342441 A1

The patent tracks actions undertaken by a person or process and if determined to be indicative of malicious intent, the fact is recorded with a time stamp. If concerning events become more frequent as time passes, if a threshold is reached, an alarm is triggered. This patent is pointed more at detecting malicious people than maliciously design machinery, and thus considerably different from our invention.

United States Patent Number 20210319108 A1

The patent (like U.S. Ser. No. 11/372,978 B2) includes a package under investigation into a program with known functionality. Like that one it thus suffers from the difficulty of differentiating the behavior of the test harness from the behavior of the package under investigation.

United States Patent Number 20050268338 A1

The patent detects infected programs by recording the pattern of execution when first introduced to the computer. If that pattern subsequently changes, it is flagged as possibly infected. Our invention does not require such an initialization step. Furthermore, the cyber security application of our patent examines the potential malware itself, rather than the damage it may have inflicted.

### BRIEF SUMMARY OF THE INVENTION

TABLE 1
Market Segment Table

| Market | Intended | Advantage Over | Unique | |
|---|---|---|---|---|
| Segment | Community | Current Practice | Feature | Claims |
| S/W Safety | Organizations that ensure | Prohibited actions are | Locating points where | 1-6 |
| Program | that system safety hazards | currently very hard to | negative behavioral | |
| Administration | do not occur in software. | test. The invention | requirements apply | |
| | Likely SEP. | enables verification | Scanning for the | |
| | | that that a prohibited | absence of a | |
| | | action is not present | behavior | |
| | | in the design. | | |
| Developer | Organizations that develop | Automatically adapts | Exports behavioral | 7-61 |
| | technical designs that can | requirement application | requirements and | 62-72 |
| | be marketed as IP. | as system develops. | testing into IP | |
| | | | customer's | |
| | | | environment | |
| | | | Safety Critical Path | |
| | | | simplification | |
| System | Organizations that produce | Reduces the labor involved | Imports Behavioral | 7-61 |
| integrator | integrated products | for integrating IP modules | requirements and | 73-83 |
| | Resolves conflicts of | into aggregate system. | testing from IP | |
| | unrelated products. | | modules. | |
| IP Broker | IP brokers need to evaluate | The invention automates | Pattern matching of | 84-87 |
| | compatibility of independent | the identification of | requirements obtained | |
| | products so that | conflicting requirements. | from one IP module | |
| | recommendations can be | | with requirements | |
| | credibly made to customers. | | obtained from other | |
| | | | IP modules. | |
| Cyber Security | Cyber security vendor | Responsive to new malware | Scans for malware | 88-99 |
| | provides users with | without necessity of | behavioral | |
| | security from malware. | human analysis. | characteristics | |
| | | Hinders development of | | |
| | | new malware. | | |

### DESCRIPTION OF INVENTION

### Definition of Behavioral Network

This invention is organized to address the varying needs of five different uses. These are a Software Safety Program like that envisioned by IEEE 1228, Software and hardware development, System Integrators, IP Brokers, and Cyber Security Vendors. It is based on rendering a computational system a kind of graph we call Behavioral Networks. Behavioral Networks retain successive behavioral steps while hiding non-behavioral aspects. This enables behaviors to be compared and searched via pattern matching algorithms.

In FIG. 1, a configuration where there is a software controller that commands controlled equipment with feedback back to the controller. In the control system literature, the controlled equipment is known as a plant. Often the plant has actuators that cause some physical process to occur. The physical process will almost always require time to elapse before it is complete. This is illustrated in FIG. 2 with an Elapsed Time box (FIG. 2-1). After elapsed time expires, the process output becomes available, and status can be read by the controller (FIG. 2-2).

FIG. 3 shows the behavioral network for this arrangement. While a behavioral network is a graph with nodes and arks, its more convenient to express them textually with names and event names. The left hand side of an equal sign (‘=’) is the name of the process, in this case, FIG. 2-2 (see FIG. 3-2). To the right of the equal sign are events separated by arrow signs (‘->’) which are transitions between events. See FIG. 2-3. In the textual notation, the process is repeated by the event FIG. 2 Pattern See FIG. 3-1.

Behavioral networks also have forking behaviors. FIG. 4 shows computational system and textual representation of a behavioral network called Simple Process. FIG. 4-1 indicates nodes and transitions. FIG. 4-2 shows a textual representation of the same process.

Behavioral networks also feature sub processes. FIG. 5 shows a sub-process with the name Subroutine_x. FIG. 5-1 shows the computational structure for Subroutine x, while FIG. 5-2 shows the textual notation for the same. Under most circumstances, computational systems are written in software languages like C, or hardware languages like VHDL. FIG. 6 shows a behavioral network being compiled from such a language.

### BRIEF DESCRIPTION OF THE DRAWINGS

FIG. 1. Controllers and controlled equipment (often called the Plant in the control theory literature) have synchronizing communication events, depicted here with arcs.

FIG. 2. Controlled Equipment (the plant) has behaviors defined by physical characteristics or (in modern systems) written as hardware description languages or software.

FIG. 3. This is the behavioral network describing the behaviors in FIG. 2.

FIG. 4. Example mechanical translation of computational system to behavioral network

FIG. 5. Example of mechanical translation of computational system to behavioral network. The example includes the translation of a sub-procedure.

FIG. 6. Control Systems (normally written in software languages, but sometimes in hardware description languages like VHDL) can be compiled to Behavioral networks.

FIG. 7. Hazards are characterized by a control system behavior pattern involving synchronizing communications, and plant behavior patterns involving the same synchronizing communications resulting in a hazardous condition.

FIG. 8. Interlock expression has a controller pattern that locates a sequence in the controller behavioral network, a plant pattern that matches the plant behavioral network, and an interlock pattern that specifies the interaction between the controller and plant.

FIG. 9. A behavioral requirement consists of a pattern to match, a payload, and a controller.

FIG. 10. Functional Requirements have a pattern match part that locates where th change will be made, and a payload that carries the change.

FIG. 11. Propagating line numbers from source code into Behavioral network enables developers to make changes at the source code level if desired.

FIG. 12. Self-propagating requirements.

FIG. 13. Estimate testing time for multiple test cases incorporated into behavioral network.

FIG. 14. Testing is run in parallel on a cloud processor.

FIG. 15. IP Developers export behavioral requirements associated with inputs, outputs, and with the IP Module itself.

FIG. 16. System integrators using IP can distribute behavioral requirements and testing requirements between the various IP modules they have licensed.

FIG. 17. Each test run on the aggregate is run independently. After all testing is complete, an operational image is created without including test code.

FIG. 18. IP brokers need to have some idea about the compatibility of IP modules from different vendors. To that end they need to perform some testing, but not the end-to-end testing that integrators need to perform.

FIG. 19. A malware investigation searches for specific behaviors in the software under investigation as potential malware. Associated analysis procedure evaluates the behaviors located by the pattern searches.

FIG. 20. Malware behavior investigations are applied in parallel at a cloud service.

FIG. 21. Malware development can be hindered by detecting the characteristics of malware.

### DETAILED DESCRIPTION OF THE INVENTION

### Description of System Pertaining to Software Safety Program Administration

This section describes the invention and how it will be used to administer a software safety program. Software Safety Programs are often called on to direct developer's response to safety hazards. A Safety Hazard Analysis will often determine that the physical system can result in harm to the users of the system, the operators of it or to the general public, or the environment.

The invention enables a script to be written which addresses the problem of recognizing when a necessary interlock is present in the system formed by a controller and controlled equipment (i.e. a plant) that can otherwise bring about safety hazards.

When software is involved, this may result in an edict to not do particular things. Testing software to ensure that it never does something is particularly hard because there is often an astronomical number of paths through a software program. Testing that the program never does something means verify each of the paths. But, given a description of the forbidden behavior, it can be searched for. With all the places in the program's behavioral network where that behavior occurs, an interlock can be placed in front of it. Then all of the places where that interlock is set can be identified, and all path segments between the two can be verified to not manipulate the interlock.

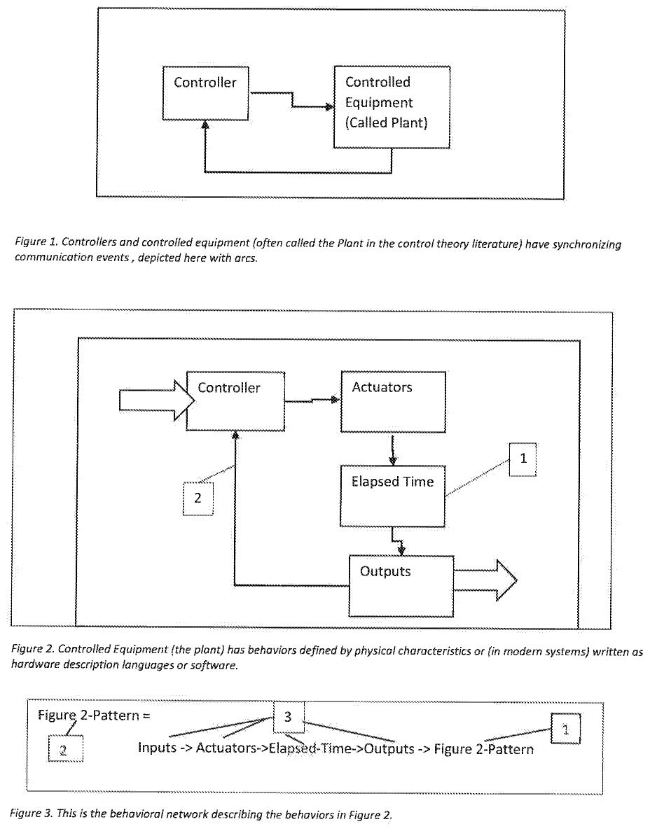

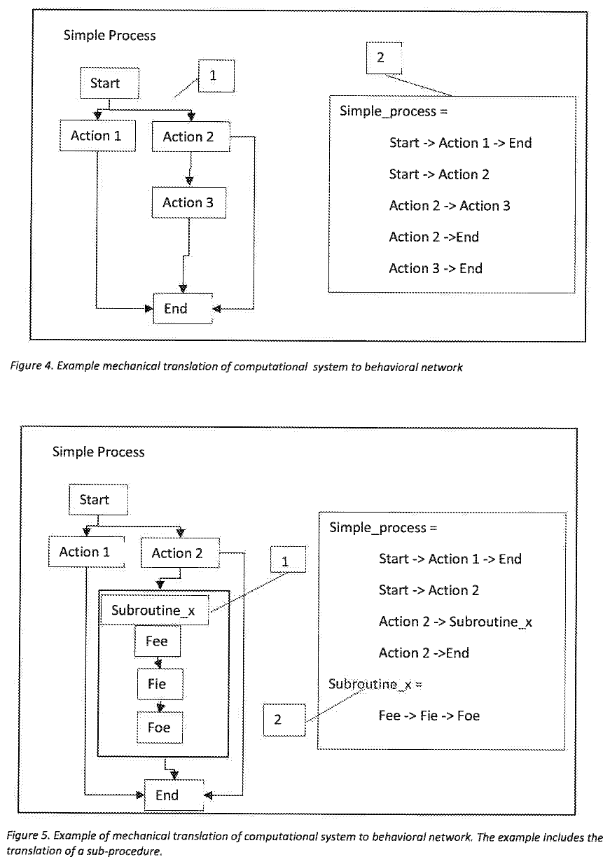

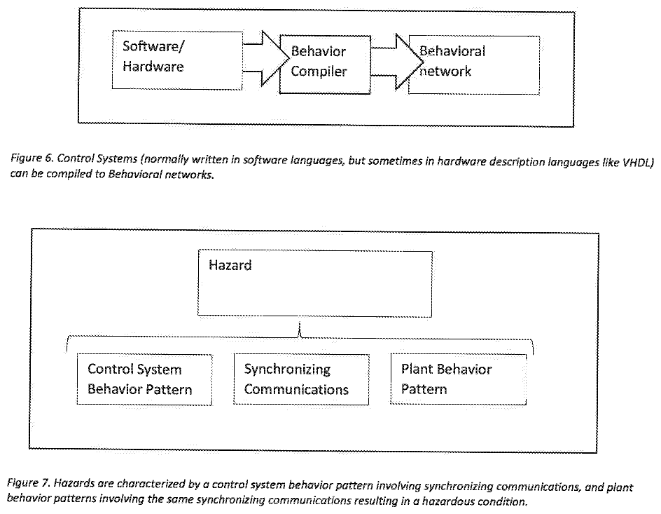

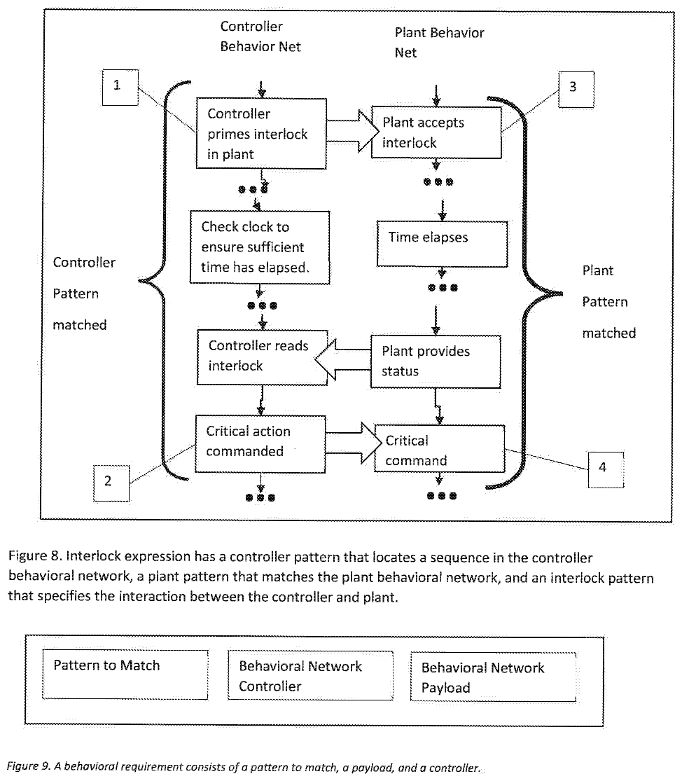

FIG. 8 shows the configuration of a generalized interlock protocol. The figure shows a controller behavior net and a plant behavior net. The plant is often hardware. Modern hardware tends to be designed with hardware languages like VHDL. An example VHDL to Behavioral Net translator is shown in Appendix B. In the worst case, a behavioral net for the plant might have to be hand-generated. FIG. 8-1 shows the beginning of the controller pattern to match with the end at FIG. 8-2. FIG. 8-3 and FIG. 8-4 show the corresponding events in the Plant pattern. Critically, the controller must be scanned to ensure that another manipulation of the interlick does not occur between FIG. 8-1 and FIG. 8-2.

### Description of Invention Elements for IP Developers

IP developers generate code for systems with components from other vendors with whom there may have been no opportunity to harmonize requirements beforehand. The invention enables export of requirements and testing that ensures ultimate compatibility. FIG. 15 illustrates a situation where an IP module exports its requirements and its testing requirements into the aggregate system. FIG. 15-1 shows requirements that are exported textually into the aggregate environment. FIG. 15-2 shows requirements that reference input or output signals or data. These are modified for compatibility with the external names of the parameters in the aggregate. FIG. 15-3 shows import of aggregate requirements into the IP module. This is generically true for plain requirements and all levels of testing.

### Description of Invention Elements Common to Developers and Integrators

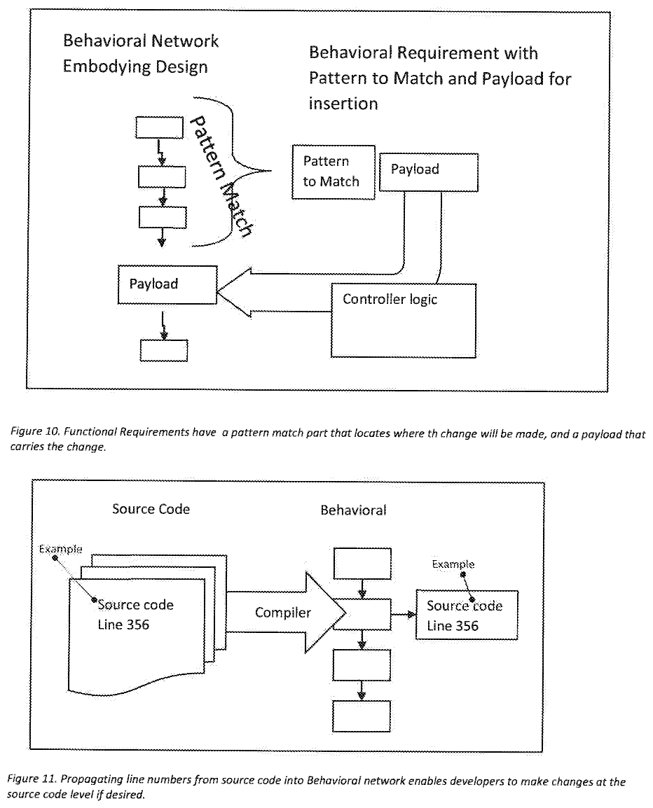

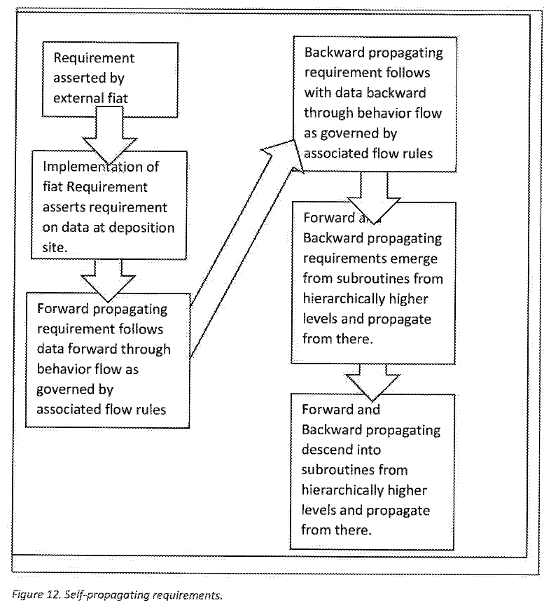

The invention enables programming by writing behavioral requirements and having the system determine whether the requirement applies, and if so, where. A behavioral requirement consists of a pattern to match, a payload, and a controller to determine what to do with the payload when the pattern matches. See FIG. 9. FIG. 10 shows graphically how the controller determines what to do with the payload when the pattern matches. Payloads can be inserted, substituted. Identified patterns can be deleted as determined by the controller.

The invention supports programming directly in Behavioral networks, but that is akin to programming in conventional assembly code. Since that is unlikely to be a popular, the compiler can propagate source code line numbers into the behavior net so that maintenance can be performed at the source code. See FIG. 11. Such information is transparent to the pattern match operations. Note that since behavioral requirements are keyed off behavior patterns, behavioral requirements can be reapplied after source code updates.

Testing logic is handled like any other payload, except that a non-behavioral tag identifies that it can be deleted when generating operational configurations. Table 2 shows the different levels of testing that are available with the invention. Assessment is testing that can be applied at compile time. Its success criteria are determined by the controller without any need for a payload. Probing includes code to insert for generation of testing results after test runs. Verifying is testing of code inserted as a test. Sometimes tests don't check what they were intended to. Verifying can ensure that testing is accurate. Prohibitions are tests that succeed when the patterns do not match.

TABLE 2
Levels of Testing

| | | | Data Collection | |
|---|---|---|---|---|
| Type of Test | Pattern | Test | Logic | Analysis Logic |
| Assessment (Assessed | Target code selected | | Instructions for | Instructions for determining |
| code not executed.) | by pattern match. | | saving data | pass/failure results. |
| Probing (Tests with | Target code selected | Test setup instructions | Instructions for | Instructions for determining |
| inserted logic) | by pattern match. | for insertion into | saving data | pass/failure results. |
| | | target code. | | |
| Verifying (Tests | Targeted Test code | Test setup instructions | Instructions for | Instructions for determining |
| applied to Tests) | selected by pattern | for insertion into | saving data | pass/failure results. |
| | match. | target code. | | |
| Prohibition | Precursor pattern that | Termination pattern | | Instructions for determining |
| | initiates critical region | that ends critical | | pass/failure results. |
| | where pattern is | region where pattern | | |
| | prohibited | is prohibited | | |
| Interlock | Precursor pattern that | Termination pattern | | Instructions for determining |
| Verification | initiates critical | that ends critical | | pass/failure results. |
| | region where pattern | region where pattern | | |
| | protected by Interlock | protected by | | |
| | | interlock | | |

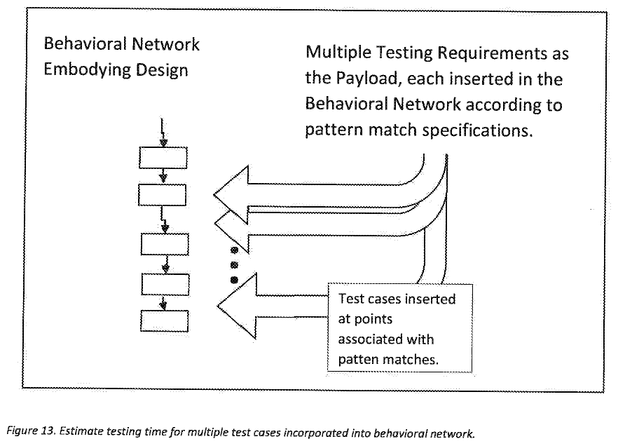

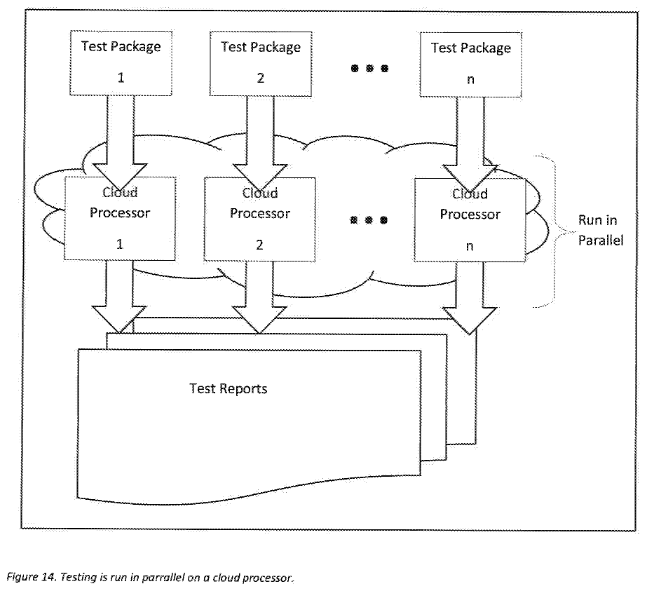

Testing often involves insertion of code at multiple points to insert data and to collect data where results appear. FIG. 13 illustrates test cases being inserted at multiple places determined by pattern match

### Description of Invention Elements for System Integrators

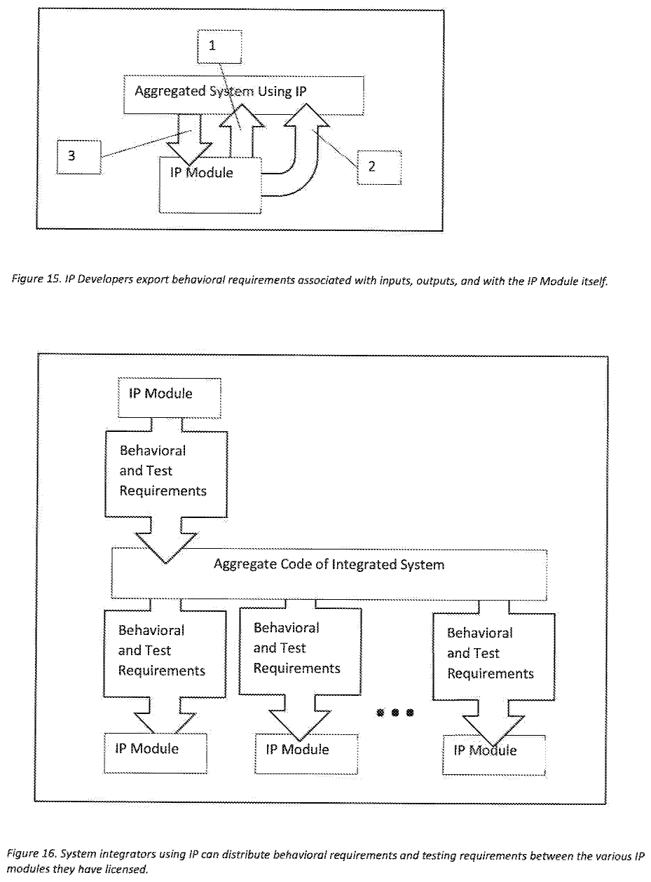

System integrators collect modules of IP from multiple vendors, often without any broad consensus on signal and safety protocols. Thus there is a need distribute requirements and testing among the collected IP modules. FIG. 16 illustrates behavioral and test requirements derived from one IP module being distributed to the other IP modules collected in the aggregate.

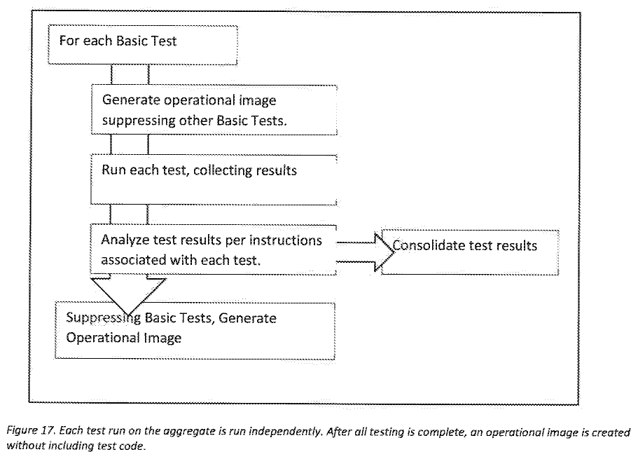

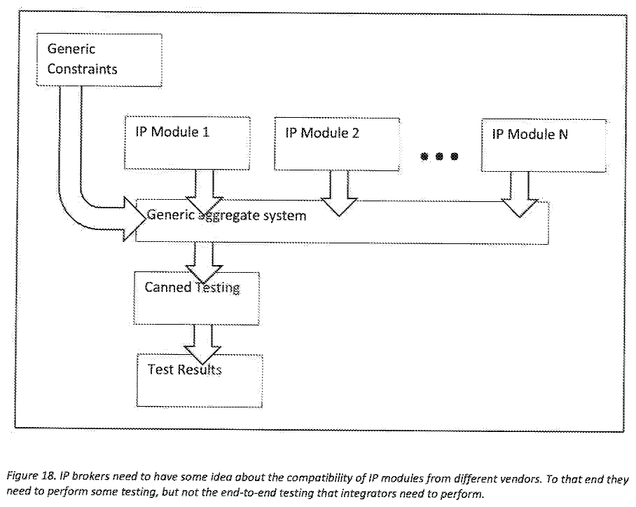

Testing is particularly important in the aggregated system to ensure that assumptions made in one module actually hold across the integrated system. System integrators are unlikely to know the intricacies of any one IP module, let alone how they interact in the aggregate. FIG. 17 shows how each basic test is run independently.

Autonomous automobiles are emblematic of the interlocking nature of safety behavioral requirements found in many large scale equipment items. Being manufactured. System integrators typically obtain IP from many different vendors and assemble designs with many interlocking safety concerns that need to be cross verified, often these disparate vendor's designs are independently engineered without knowledge of each other. This invention addresses the problem of how to construct and efficiently test safety constraints when these different IP products are consolidated into an integrated design.

### Description of Invention Elements for IP Brokers

Brokers need some understanding of the compatibility of the IP modules they market. They do not, generally speaking, need to perform end-to-end testing that is packaged with the IP modules. But they need to know if there are incompatible requirements. Consequently, they do not need to perform the massive testing operations that can be performed at a cloud services agency. See FIG. 18.

### Description of Invention Elements for Cyber Security Vendors

Cyber Security vendors are called on to ascertain whether potential malware is malignant or not. The capability of searching the code of potential malware enables that determination to be based in a more intimate manner than is true presently. It also malware to be flagged when it has not previously been identified as such. The invention does not elucidate criteria in the abstract for identifying malware. Rather it provides the machinery for rapidly searching potential malware for behaviors that are indicative of malware. It also enables detection of malware development when such developers test and tune malware.

FIG. 19 shows a Malware Investigation applying behavioral search, looking for specific behaviors in the software under investigation (FIG. 19-1). An associated analysis procedure applies the criteria that for flagging as possible malware (FIG. 19-2). If the behaviors are not found (i.e. all of the pattern matches fail), then the analysis procedure is not triggered.

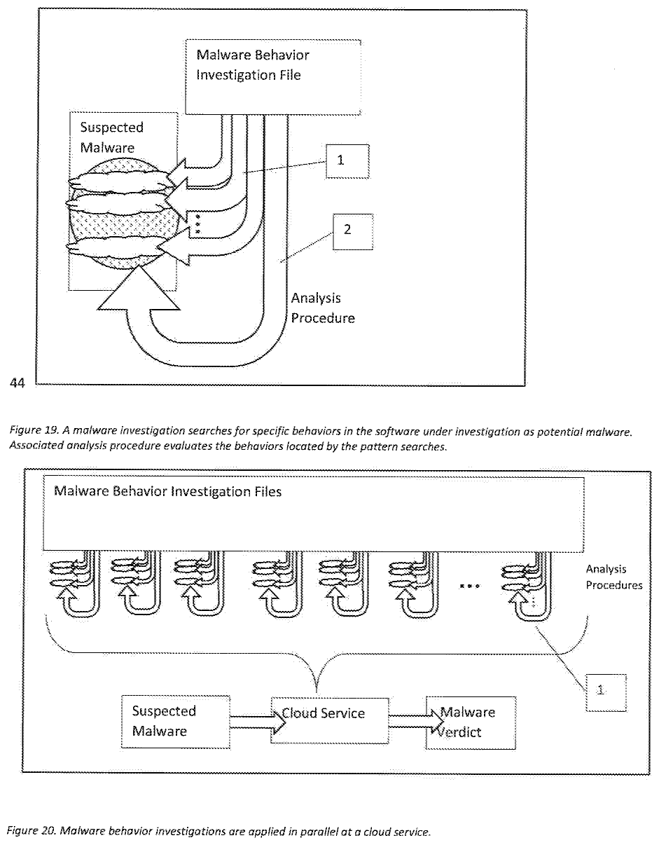

There are many ways that malware can manifest. Consequently, there are many malware investigation files. FIG. 20 shows the parallel application of Malware Investigation Files to suspected malware. FIG. 20-1 is one malware investigation.

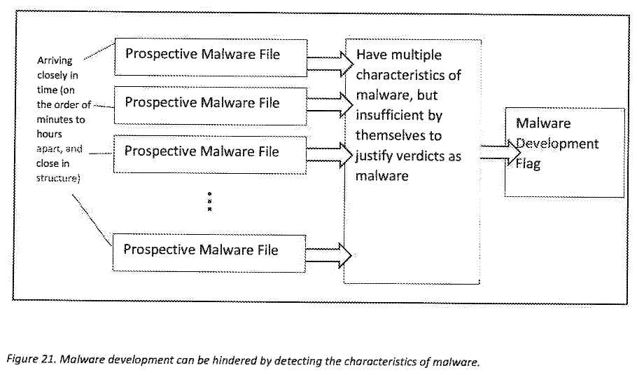

It is almost inevitable that malware developers will try to tune their software by multiple runs of malware detection services. See FIG. 21. Such development can be hindered by randomizing the responses to the malware check, and by flagging it for notifying law enforcement.

### For S/W Developers

In software development, a behavioral requirement is often articulated and then the engineering effort is devoted to designing a digital system that meets that behavioral requirement. There is thus a latency between establishment of a new behavioral requirement and the availability of new code fulfilling the behavioral requirement. This invention allows the immediate generation of code directly from the behavioral requirement. The behavioral requirement itself becomes source code. The behavioral requirement also autogenerates test code. Furthermore, it enables IP generation that in addition to delivering code, delivers embedded testing that is automatically configurable for use by integrators, thus enabling end-to-end testing without requiring the integrators to cross-test compatibility of purchased IP modules of which they are not familiar with the details.

### For S/W Developers, System Integrators

This invention is directed at improving the testing of FPGAs and computer software systems. As computer software and digital hardware designs develop, there is a tendency for the system to drift away from initially accomplished testing, so that what was originally proven by testing, becomes less appropriate as the design matures. Reengineering older testing is both expensive, and detrimental to meeting tight timelines for windows of market opportunity. This invention solves that by tying behavioral requirements, testing and behavioral structure to a common format we call a behavioral network. Behavioral networks enable pattern matching between system behaviors, behavioral requirements, and needed verification of system behavior. This enables testing to grow and morph automatically as the system develops and matures. It also enables testing of testing to verify that testing remains appropriate as the meaning of behaviors evolve during development.

### For System Integrators.

The much anticipated arrival of autonomous automobiles, with reliance of the automotive sector on parts and IP from many vendors creates a situation where safety of the product depends on the interoperability of safety testing of components which were engineered independently. It is currently difficult to integrate testing of IP products from independent vendors. This invention enables integration of testing of IP products not specifically designed for each other. At the same time, it protects the privacy each vendor's implementation from competitors.

Malware has become a problem for users of any system connected to the internet

In addition, there is a growing market for digital intellectual property and with it an increased need for interoperability. Interoperability, particularly of safety constraints associated with autonomous automobiles, interoperability of intellectual

### Description

Software design, programmable hardware design files, logical ASIC designs and physical simulations may all be described by connected behaviors. Behaviors have names associated with rudimentary behaviors and as nodes, can be collected into behavioral networks. Each node of a behavioral network designates a rudimentary behavior, and some number of designated next nodes. A node may optionally have a name associated with it. Behavioral requirements are themselves behavioral networks that can be pattern matched with behavior descriptions, also formatted as behavioral networks. Behavioral requirements may be decorated with capture names that record references to matched segments and editing sequences that can be performed on matched segments.

Behavioral requirements can be formulated as patterns that are pattern matched on the network. When the pattern match succeeds, the network is said to comply with the behavioral requirement. Behavioral requirements can be implemented on the network with patterns that locate points in the behavioral network where behaviors should be incorporated. In this way, new behaviors can be added to more rudimentary networks.

Behavioral networks may be compiled into conventional software, programmable hardware design files (eg. FPGA design files), and ASIC designs. Simulation files can in principle, be compiled from behavioral networks in the same way. As a practical matter, however, simulation programs are more readily described by manually generated behavioral networks describing behaviors that can be engaged in.

Testing is incorporated as temporary behaviors included for testing, and not included in production releases. Testing of testing can be incorporated in the same way to ensure that testing actually furnished the intended information. Automatic examination can be included that checks the configuration of the behavioral network with running a physical test.

Hazard analyses are often produced by System Safety investigations. They commonly appear as “negative behavioral requirements” for software systems. Negative behavioral requirements are particularly hard to verify, because they essentially say “Don't do this. Ever.” That means that every possible path through the Behavioral network needs to be verified. That often results in an astronomical number of test and the dictum that Negative behavioral requirements are untestable.

Conventionally, negative behavioral requirements have been handled by declaring a critical path over which enhancements are avoided, thereby reducing the number of paths that have to be tested to ensure that none of them produce the hazard. That isn't so bad for a new development with few enhancements already implemented. For a relatively mature design, removing code so that a negative behavioral requirement can be completely test can be a difficult and expensive process. This is where the invention helps out. When behavioral requirements are associated with a priority, the low priority behavioral requirements can be suppressed, thus needing fewer tests.

Negative behavioral requirements can also be handled by introducing interlocks that prevent the hazardous behavior in either the controlled equipment (called the plant in control system theory) or in the control system itself (or both).

When the hazard identification fails due to time or other resource not being sufficient, behavioral requirements can be simplified. Automatic behavioral requirement reduction can be accomplished (Claim 34) if the behavioral requirements were behavioral requirements with attendant pattern matching. Reimplementation occurs by starting from the beginning and playing through the behavioral requirement data base. A behavioral requirement is backed off by suppressing its implementation when the behavioral requirement data base is traversed. Remember that behavioral requirements have behavioral pattern matching conditions that locate their applicability.

This makes them flexible with respect to changes in the codebase.

Implementation of a behavioral design specification can be one or more of the following: programmable hardware design files, ASIC designs, and conventional software.

What follows is an example implementation of a compiler (written in CommonLisp) of a Lisp to Behavior net. Following that is an example VHDL to Behavior Net compiler.
Example Lisp to Behavioral network Compiler

1. Given a pre-identified hazardous behavior description, a means for searching the code for instances of said behavior and the means for rendering the code searchable for behavior patterns.

2. claim 1 wherein the said means for rendering the code searchable renders the code as a behavioral network.

3. claim 2 wherein the effect of the behavioral network is achieved with a non-behavioral network by skipping non-behavioral nodes when traversing nodes of said nonbehavioral network.

4. claim 1 wherein the said pre-identified hazardous behavior description is formatted as a behavioral network.

5. claim 1 wherein said means for searching the code is pattern matching the said hazardous behavior description with the said code rendered searchable.

6. claim 1 wherein an interlock is specified in conjunction with the hazardous behavior description and said behavior search verifies the presence or absence of behaviors bypassing the interlock.

7. A system for editing a behavioral network to incorporate one or more changes embodied by a behavioral requirement, comprising
a. performing an automated analysis of the behavioral network to determine the portions of the behavioral network which requires editing according to the behavioral requirement; and
b. editing the portion of the behavioral network which requires editing according to the behavioral requirement.

8. The system for editing a behavioral network as recited in claim 7 wherein the behavioral network is achieved with a non-behavioral network by skipping non-behavioral nodes when traversing nodes of said non-behavioral network.

9. The system for editing a behavioral network to incorporate one or more changes embodied by a behavioral requirement as recited in claim 7 wherein the behavioral requirement is formatted as a behavioral network.

10. The system for editing a behavioral network with the behavioral requirement as recited in claim 7 wherein the behavioral requirement is exported from a subroutine present in the behavioral network and imposed on the behavioral network with a pattern customized by subroutine calling parameters.

11. The system for editing a behavioral network as recited in claim 7 wherein the behavioral network was derived from a computational system as follows: a. copying event names; and
b. copying non-behavioral information as items to be ignored by pattern matching, tagging them as non-behavioral and identifying at least one outgoing arc for subsequent behaviors; and
c. copying computational system operation steps as behavioral steps and identifying at least one outgoing arc for subsequent behaviors; and
d. Copying decision steps as behavioral network forking behaviors and identifying alternative outgoing arcs for attaching subsequent behaviors; and
e. Copying subroutine calls as behavior synchronizations and identifying outgoing arcs for subsequent behaviors; and
f. copying communication events as behavior communication events and identifying outgoing arcs for subsequent behaviors; and
g. Identifying final nodes and terminating behavior sequences.

12. The system for editing a behavioral network as recited in claim 7 wherein the behavioral network was compiled from a conventional hardware or software language as follows:
designating non-behavioral information as items to be ignored by pattern matching, tagging them as non-behavioral and identifying at least one outgoing arc for subsequent behaviors; and
a. compiling computational system operation steps as behavioral steps and identifying at least one outgoing arc for subsequent behaviors; and
b. compiling decision steps as behavioral network forking behaviors and identifying alternative outgoing arcs for attaching subsequent behaviors; and
c. generating subroutine calls as behavior synchronizations and identifying outgoing arcs for subsequent behaviors; and
d. generating communication events as behavior communication events and identifying outgoing arcs for subsequent behaviors; and
e. generating final nodes and terminating behavior sequences.

13. The system for editing a behavioral network to incorporate one or more changes embodied by a behavioral requirement as recited by claim 7 wherein the behavioral network has been compiled from a conventional hardware or software language and source code locations references of the original software are embedded as nonbehavioral tokens in the product behavioral network.

14. The system for editing a behavioral network with the behavioral requirement as recited in claim 7 wherein said automated analysis of the behavioral network to determine the portion of the behavioral network requiring editing comprises:
a. Utilizing a pattern derived from the behavioral requirement for locating the parts of the behavioral network needing to be edited; and
b. pattern matching the pattern with the behavioral network to select the parts of the behavioral network needing to be edited; and
c. determining the editing operations from said pattern; and
d. editing the selected portions of the behavioral network with the editing operations in the pattern.

15. The system for editing a behavioral network with the behavioral requirement as recited in claim 14 wherein the behavioral requirement is imported to a subroutine present in the behavioral network and imposed on said subroutine with a pattern customized by subroutine calling parameters.

16. The system for editing a behavioral network as recited in claim 14 wherein said editing comprises deleting network components from the portion of the behavioral network which has been selected for editing.

17. The system for editing a behavioral network as recited in claim 14 wherein said editing comprises:
a. deleting network components from the portion of the behavioral network which has been selected for editing; and
b. substituting alternate network components for the deleted network components.

18. The system for editing a behavioral network as recited in claim 14 wherein the behavioral requirements and locations of inclusion in the behavioral network or source code are collected for inclusion in one or more of the following: a cross-reference or a data base.

19. The system for editing a behavioral network as recited in claim 14 wherein said editing comprises adding additional network components to the portion of the behavioral network which has been selected for editing.

20. The system for editing a behavioral network as recited in claim 14 wherein said editing a behavioral requirement and locations of inclusion in the behavioral network or source code are collected for inclusion in one or more of the following: a cross-reference or a data base.

21. The system for editing a behavioral network to incorporate one or more changes embodied by a behavioral requirement recited in claim 7 wherein the behavioral requirement has a priority associated with it.

22. The system for editing a behavioral network to incorporate one or more changes embodied by a behavioral requirement as recited in claim 21 wherein said priority is used to reduce the number of test cases when the amount of testing exceeds the testing budget and lower priority behavioral requirements are removed until the testing budget is met, unless a higher priority behavioral requirement requires it.

23. A system for testing a behavioral network according to a behavioral requirement comprising:
a. performing an automated analysis of the behavioral network to select the portion of the behavioral network which requires testing; and
b. testing the portion of the behavioral network which requires testing.

24. The system for testing a behavioral network recited in 21 wherein the behavioral network is achieved with a non-behavioral network by skipping non-behavioral nodes when traversing nodes of said non-behavioral network.

25. The system for testing a behavioral network as recited in claim 21 wherein the behavioral network was derived from a computational system as follows: a. copying event names; and
b. copying non-behavioral information as items to be ignored by pattern matching, tagging them as non-behavioral and identifying at least one outgoing arc for subsequent behaviors; and
c. copying computational system operation steps as behavioral steps and identifying at least one outgoing arc for subsequent behaviors; and
d. Copying decision steps as behavioral network forking behaviors and identifying alternative outgoing arcs for attaching subsequent behaviors; and
e. Copying subroutine calls as behavior synchronizations and outgoing arcs for subsequent behaviors; and
f. copying communication events as behavior communication events and identifying outgoing arcs for subsequent behaviors; and
g. Identifying final nodes and terminating behavior sequences.

26. The system of testing a behavioral network as recited in claim 21 wherein said testing is an assessment of the portions of the behavioral network selected by said pattern matching without executing said portions.

27. The system for testing a behavioral network according to a testing behavioral requirement as recited in claim 21 wherein said automated analysis of the behavioral network and the testing behavioral requirement to select the portion of the behavioral network which requires testing comprises:
a. Obtaining a pattern from the testing behavioral requirement for locating the portions of the behavioral network needing to be tested; and
b. pattern matching the pattern with the behavioral network to determine the parts of the behavioral network needing to be tested; and
c. generating behavioral steps to perform the testing; and
d. generating behavioral steps to generate one or more test results.

28. The system of testing a behavioral network as recited in claim 27 wherein at least one result of said testing is written to a test results file.

29. The system of testing a behavioral network as recited in claim 27 wherein said testing performs
a. insertion of zero or more setup steps as specified by the testing behavioral requirement to initialize the test sequence; and
b. execution of one or more sequences of behavioral network steps to generate needed test data; and
c. collection of one or more data items as specified by the testing behavioral requirement to generate test results; and
d. computation of one or more test results as specified by the testing behavioral requirement.

30. The system of testing of a behavioral network as recited in claim 27 wherein said testing verifies the veracity of test code present in the behavioral network.

31. The system of testing of a computational system having a behavioral network as recited in claim 30 wherein said testing verifies the veracity of test code by one or more of the following measures:
a. Generating codes to check that the test code has the intended relationship to other code; and
b. Generating codes checking that the test code indeed verifies the results tested for; and
c. Collecting results generated.

32. The system of testing of a behavioral network as recited in claim 27 wherein said testing is performed at execution time.

33. The system of testing a behavioral network as recited in claim 27 wherein the testing behavioral requirement is a prohibition as follows:
a. The pattern match selects a region of interest; and
b. All paths within the region of interest are identified; and
c. Testing criteria are tailored for each path; and
d. Testing specified in the test behavioral requirement is generated as tailored for each path.

34. The system of testing of a behavioral network as recited in claim 27 wherein provision is made for managing the complexity of testing a behavioral network comprising: a. performing one or more of the following:
i. counting the number of test sequences,
ii. predicting the amount of sequential test time that would need to be expended to execute testing,
iii. predicting the amount of wall-clock time that would be needed to be expended to execute testing after accounting for testing that can be performed in parallel, and
b. if any of the following (the number of testing sequences, the total testing time, or the wall-clock time) exceeds budgets for testing, then prepare a list of behavioral requirements that could reduce the testing if they were withdrawn.

35. The system for editing a behavioral network as recited in claim 7 wherein said editing operations on the behavioral network formatted computational system comprises adding additional network components to the portion of the behavioral network which has been selected for editing.

36. The system for editing a behavioral network as recited in claim 7 wherein said editing operations on the behavioral network formatted computational system comprises deleting network components from the portion of the behavioral network which has been selected for editing.

37. The system for editing a behavioral network as recited in claim 7 wherein:
a. deleting network components from the portion of the behavioral network which has been selected for editing; and
b. substituting alternate network components for the deleted network components.

38. The system for testing a behavioral network as recited in claim 27 wherein the behavioral network formatted computational system was derived from a computational system as follows:
a. copying event names; and
b. copying non-behavioral information as items to be ignored by pattern matching, tagging them as non-behavioral and identifying at least one outgoing arc for subsequent behaviors; and
c. copying computational system operation steps as behavioral steps and identifying at least one outgoing arc for subsequent behaviors; and
d. copying decision steps as behavioral network forking behaviors and identifying alternative outgoing arcs for attaching subsequent behaviors; and
e. copying subroutine calls as behavior synchronizations and outgoing arcs for subsequent behaviors; and
f. copying communication events as behavior communication events and identifying outgoing arcs for subsequent behaviors; and
g. identifying final nodes and terminating behavior sequences.

39. The system for testing a behavioral network formatted computational system according to a testing behavioral requirement as recited in claim 27 wherein said automated analysis of the computational system and the testing behavioral requirement to select the portion of the behavioral network which requires testing comprises:
a. obtaining a pattern from the testing behavioral requirement for locating the portions of the behavioral network needing to be tested; and
b. pattern matching the pattern with the behavioral network to determine the parts of the behavioral network needing to be tested; and
c. generating behavioral steps to perform the testing; and
d. generating behavioral steps to generate one or more test results.

40. The system of testing a behavioral network as recited in claim 39 wherein at least one result of said testing is written to a test results file.

41. The system of testing a behavioral network as recited in claim 27 wherein said testing is an assessment of the portions of the behavioral network selected by said pattern matching without executing said portions.

42. The system of testing of a behavioral network-formatted computational system as recited in claim 27 wherein said testing performs
a. insertion of zero or more setup steps as specified to initialize the test sequence; and
b. execution of one or more test sequences to generate needed test data; and
c. collection of one or more data items to generate test results; and
d. computation of one or more test results.

43. The system of testing a behavioral network-formatted computational system as recited in claim 27 wherein said testing involves execution of behavioral network nodes.

44. The system of testing a behavioral network-formatted computational system as recited in claim 27 wherein said testing performs
a. insertion of zero or more setup steps as specified by the testing behavioral requirement to initialize the test sequence; and
b. execution of one or more preexisting sequences of behavioral network steps to generate needed test data; and
c. collection of one or more data items as specified by the testing behavioral requirement to generate test results; and
d. computation of one or more test results as specified by the testing behavioral requirement.

45. The system of testing of a behavioral network-formatted computational system as recited in claim 27 wherein said testing verifies the veracity of test code present in the behavioral network.

46. The system of testing of a computational system having a behavioral network-formatted computational system as recited in claim 27 wherein said testing verifies the veracity of test code by one or more of the following measures:
a. generating codes to check that the test code has the intended relationship to other code; and
b. generating codes check that the test code indeed generates the values the tested code recognizes as proper, and
c. generating codes that check that the test code indeed generates the values the tested code recognizes as improper; and
d. generating codes that check that results the test code generates from test data are correct.

47. The system of testing of a behavioral network-formatted computational system as recited in claim 20 wherein said testing is performed at execution time.

48. The system of testing a behavioral network-formatted computational system as recited in claim 27 wherein the testing behavioral requirement is a prohibition as follows: a. the pattern match selects a region of interest; and
b. all paths within the region of interest are identified; and
c. testing criteria are tailored for each path; and
d. testing specified in the test behavioral requirement is generated as tailored for each path.

49. The system of behavioral requirements as recited in claim 7 wherein the target of the requirement is a data value at the pattern specified point.

50. The system of behavioral requirements as recited in claim 49 wherein the requirement propagates either forward or backward or both forward and backward.

51. The system of behavioral requirements as recited in claim 50 wherein the requirement propagates up through a subroutine call to the next hierarchical level and the name changes to what it is called at that level and said subroutine is present in the development environment.

52. The system of behavioral requirements as recited in claim 50 wherein the requirement propagates down through a subroutine call to the next hierarchical level and the name changes to what it is called at that level and said subroutine is present in the development environment.

53. The system of testing as recited in claim 20 wherein the target of the requirement is a data value at the pattern specified point.

54. The system of testing as recited in claim 53 wherein the requirement propagates either forward or backward or both forward and backward.

55. The system of testing as recited in claim 54 wherein the requirement propagates up through a subroutine call to the next hierarchical level and the name changes to what it is called at that level and said subroutine is present in the development environment.

56. The system of testing as recited in claim 55 wherein the requirement propagates down through a subroutine call to the next hierarchical level and the name changes to what it is called at that level and said subroutine is present in the development environment.

57. A system for generating an image of a test run of a behavioral network with embedded testing, which system comprises selecting one or more test procedures from the set of test procedures associated with the behavioral network under consideration and preparing an executable image for the testing hardware and running the generated image, collecting any test result files and performing analysis of test results as specified for each test procedure.

58. The system for generating an image of a test run of a behavioral network as recited in claim 57 wherein the behavioral network is achieved with a non-behavioral network by skipping non-behavioral nodes when traversing nodes of said non-behavioral network.

59. The system of claim 57 wherein the following steps are performed for the test procedures selected for running:
a. determining whether the test is an examination only of behavior sequences; and
b. if so, identifying the behavioral network paths and performing the following
i. generating behaviors to initialize examination of each path; and
ii. one or more behavioral steps to examine the behaviors of each path; and
iii. identifying the data analysis steps associated with the test run; and iv. generating the behaviors to accomplish said analysis; and
c. otherwise, if the test requires execution of the computational system, performing the following:
i. identifying any initialization steps associated with the test; and
ii. generating said initialization steps (if any) in the test run; and
iii. identifying the paths necessary for the test; and iv. generating the steps of said paths; and
v. identifying the data analysis steps to operate on the data resulting from the test run; and
vi. identifying the data analysis steps associated with the test run; and vii. generating the behaviors to accomplish said analysis.

60. The system for generating a test run for a behavioral network with embedded testing as recited in claim 57, wherein said data resulting from the test run is saved in a test results file.

61. The system for generating a test run of a computational system having a behavioral network with embedded testing as recited in claim 57, wherein said test is collected with zero or more other ready-to-run tests for testing on one or more servers “in the cloud.”

62. A system for making available one or more behavioral requirements provided in connection with IP code.

63. The system for making available one or more behavioral requirements provided in connection with IP code as recited in claim 62 wherein said computational system is formatted as a Behavioral Network.

64. The system of claim 63 wherein the behavioral network is achieved with a nonbehavioral network by skipping non-behavioral nodes when traversing nodes of said non-behavioral network.

65. The system for making available one or more behavioral requirements provided in connection with IP code as recited in claim 63 wherein the IP code carries one or more behavioral requirements associated with an input or output parameter of the IP code and there is an automated analysis to determine where the behavioral requirement applies in the computational system utilizing said IP code.

66. The system for making available one or more behavioral requirements provided in connection with IP code as recited in claim 62, wherein said automated analysis is a pattern matching operation with a pattern derived from the behavioral requirement with said behavioral network formatted computational system.

67. The system for making requirements available from IP, as recited in claim 66 wherein the behavioral requirements are associated with one or more of the following: input parameters, output parameters, or instantiation of the IP module itself.

68. The system for making requirements available from IP, as recited in claim 67 wherein the requirements are propagated according to rules associated with the said requirements.

69. The system for making available one or more behavioral requirements provided in connection with IP code as recited in claim 62, wherein the behavioral requirements express one or more of the following
a. editing the functionality in the computational system utilizing said IP code,
b. testing the functionality in the computational system utilizing said IP code,
c. verifying the testing of the computational system utilizing said IP code,
d. verifying the testing verification of the computational system utilizing said IP code.

70. The system for making available one or more behavioral requirements provided in connection with IP code as recited in claim 65 wherein the behavioral requirements and locations of inclusion in the behavioral network or source code are collected for inclusion in one or more of the following: a cross-reference or a data base (e.g. IBM Doors (rm)).

71. A system for generating a testing image of a behavioral network with embedded testing, which system comprises:
a. verifying that all testing behavioral requirements are satisfied; and
b. verifying that all constraints exported from any behavioral requirements are satisfied; and
c. identifying resource behavioral requirements and provide indicated resources; and
d. identifying behavioral steps and provide corresponding steps in the executable image; and
e. identifying non-behavioral compiling information and integrating it according to syntactical format;

72. The system for generating a testing image of a behavioral network recited in claim 71 wherein the behavioral network is achieved with a non-behavioral network by skipping non-behavioral nodes when traversing nodes of said non-behavioral network.
System Integrator (Integrating Behavioral requirements Provided by IP code into Aggregate Code)

73. A system for integrating one or more behavioral requirements from code distributed as IP into aggregate computational systems utilizing IP code.

74. The system for integrating one or more behavioral requirements from code distributed as IP into aggregate computational systems utilizing IP code as recited in claim 73 wherein said computational system is formatted as a behavioral network.

75. The system for integrating one or more behavioral requirements from code distributed as IP recited in claim 74 wherein the behavioral network is achieved with a nonbehavioral network by skipping non-behavioral nodes when traversing nodes of said non-behavioral network.

76. The system of integrating one or more behavioral requirements from code distributed as IP into aggregate computational systems formatted as a Behavioral Network, utilizing said IP code as recited in claim 73 wherein the IP code carries one or more behavioral requirements associated with an input or output parameter of the IP code and there is an automated analysis to determine where the behavioral requirement applies in the computational system utilizing said IP code.

77. The system for integrating one or more behavioral requirements from code distributed as IP into the aggregate computational system formatted as a behavioral network, utilizing said IP code as recited in claim 76, wherein said automated analysis is a pattern matching operation with a pattern derived from the behavioral requirement with said behavioral network formatted computational system.

78. The system for integrating at least one behavioral requirements from code distributed as IP into the aggregate computational system formatted as a behavioral network, utilizing said IP code as recited in claim 77, wherein the behavioral requirements express one or more of the following
a. editing the functionality in the computational system utilizing said IP code,
b. testing the functionality in the computational system utilizing said IP code,
c. verifying the testing of the computational system utilizing said IP code,
d. verifying the testing verification of the computational system utilizing said IP code.

79. The system for integrating one or more behavioral requirements from code distributed as IP into the aggregate computational system as recited in claim 78 wherein the behavioral requirements and locations of inclusion in the behavioral network or source code are collected for inclusion in at least one of the following: a cross-reference, or a data base.

80. A system for generating an operationally usable image of a behavioral network with embedded testing, which system comprises:
a. verifying that all testing behavioral requirements are satisfied; and
b. verifying that all constraints exported from any behavioral requirements are satisfied; and
c. identifying resource behavioral requirements and provide indicated resources; and
d. identifying behavioral steps and provide corresponding steps in the executable image; and
e. identifying non-behavioral compiling information and integrate it according to syntactical format; and
f. compiling to operational format

81. The system for generating an operationally useable image of a behavioral network recited in claim 80 wherein the behavioral network is achieved with a non-behavioral network by skipping non-behavioral nodes when traversing nodes of said nonbehavioral network.

82. A system for generating an operational testing image of a behavioral network with embedded testing, which system comprises:
a. verifying that all testing behavioral requirements are satisfied; and
b. verifying that all constraints exported from any behavioral requirements are satisfied; and
c. identifying resource behavioral requirements and provide indicated resources; and
d. identifying behavioral steps and provide corresponding steps in the executable image; and
e. identifying non-behavioral compiling information and integrate it according to syntactical format.
f. compiling to operational format.

83. The system for generating an operational testing image of a behavioral network as recited in claim 82 wherein the behavioral network is achieved with a non-behavioral network by skipping non-behavioral nodes when traversing nodes of said nonbehavioral network.

84. A system for verifying the compliance properties of one or more IP modules formatted as behavioral networks offered as prospective components of a larger system.

85. The system for verifying the compliance properties of one or more IP modules formatted as behavioral networks as recited in claim 84 wherein the behavioral network is achieved with a non-behavioral network by skipping non-behavioral nodes when traversing nodes of said non-behavioral network.

86. The system for verifying the compliance properties recited in claim 84 wherein an automated analysis of the behavioral requirements associated with IP modules are in conflict.

87. The system for verifying compliance properties as recited in claim 86 wherein the conflict is determined by pattern matching the behavioral requirements with each other.

88. A system for detecting malware in a behavioral network comprising:
a. a behavioral network representing an item of suspected malware, and
b. a file containing previously identified prohibited malware criteria, and
c. performing an automated analysis of the behavioral network to identify the sites in the behavioral network matching the patterns associated with malware as defined in a prohibited behavior file;

89. The system for detecting malware in a behavioral network as recited in claim 88 wherein the behavioral network is achieved with a non-behavioral network by skipping non-behavioral nodes when traversing nodes of said non-behavioral network.

90. The system for detecting malware recited in claim 88 wherein the Behavioral Network is derived from a machine language program as follows: a. autogenerating event names
b. ignoring non-behavioral steps in the executable. and
c. copying computational system operation steps as behavioral steps and identifying at least one outgoing arc for subsequent behaviors; and
d. copying decision steps as behavioral network forking behaviors and identifying alternative outgoing arcs for attaching subsequent behaviors; and
e. copying subroutine calls as behavior synchronizations and identifying outgoing arcs for subsequent behaviors; and
f. copying communication events as behavior communication events and identifying outgoing arcs for subsequent behaviors; and
g. identifying final nodes and terminating behavior sequences.

91. The system for detecting malware recited in claim 88 wherein the malware criteria consist of one or more behavior patterns together with zero or more data collection instructions targeted at pattern match locations and one or more data analysis instruction sequences.

92. The system for detecting malware in a behavioral network as recited in claim 91, wherein zero or more of the following occurs “in the cloud”: pattern matching, data collection, and data analysis.

93. The system for detecting malware recited in claim 91 wherein the conclusion about whether or not malware is indicated is determined by the said data analysis instruction sequences.

94. The system for detecting malware recited in claim 92 wherein characteristics of prospective malware are preserved for comparison with subsequent prospective malware trials.

95. A system for detecting malware development that searches a behavioral network of potential malware for behavior characteristic of malware and upon finding such behaviors, applies zero or more analyses to determine if malware development is indicated.

96. The system for detecting malware development of claim 95 wherein the behavioral network is achieved with a non-behavioral network by skipping non-behavioral nodes when traversing nodes of said non-behavioral network.

97. The system for detecting malware development in a behavioral network as recited in claim 96 wherein at least one or more of the following measures are used to ascertain that malware is being tuned by the developer of said malware:
a. multiple closely related versions of prospective malware are submitted within a preset time limit,
b. some preset number of submitted prospective malware files within a preset time limit and have characteristics that resemble identified malware behaviors, but insufficient.

98. The system for detecting malware in a behavioral network as recited in claim 97, wherein the anti-malware development response includes one or more of the following: a. flagging occurrence to system operators as early warning of potential new malware specie,
b. randomizing the verdict of malware/not malware,
c. refusing to generate malware verdicts,
d. flagging request to system operators,
e. supplying wrong answers to the service request

99. The system for detecting malware in a behavioral network as recited in claim 98, wherein the behavioral network was derived from a computational system as follows: a. copying event names; and
b. copying non-behavioral information as items to be ignored by pattern matching, tagging them as non-behavioral and identifying at least one outgoing arc for subsequent behaviors; and
c. copying computational system operation steps as behavioral steps and identifying at least one outgoing arc for subsequent behaviors; and
d. copying decision steps as behavioral network forking behaviors and identifying alternative outgoing arcs for attaching subsequent behaviors; and
e. copying subroutine calls as behavior synchronizations and identifying outgoing arcs for subsequent behaviors; and
f. copying communication events as behavior communication events and identifying outgoing arcs for subsequent behaviors; and
g. Identifying final nodes and terminating behavior sequences.
